(19) United States
(12) Patent Application Publication
(10) Pub. No.: US 2010/0237164 A1
(43) Pub. Date: Sep. 23, 2010

(54) Sprinkler and Method for Controlling the Same

(76) Inventor: Si Chung Noh, Gyeonggi-do (KR)

Correspondence Address: SALIWANCHIK LLOYD & SALIWANCHIK;A PROFESSIONAL ASSOCIATION, PO Box 142950, GAINESVILLE, FL, 32614, US

(21) Appl. No.: 12/681,400

(22) PCT Filed: Oct. 8, 2007
(86) PCT No.: PCT/KR07/04892

§ 371 Date: Apr. 2, 2010

(51) Int. Cl. B05B 17/04; B05B 15/00; B05B 1/30

(52) U.S. Cl. 239/11; 239/289; 239/569

(57) ABSTRACT

A sprinkler and a method for controlling the same are disclosed. The sprinkler and the method can uniformly supply water on a variety of topographies without any waste of water. The sprinkler includes a fluid supply pipe to supply fluid; a nozzle to spray the fluid supplied from the fluid supply pipe; a flux regulator to control an amount of the fluid supplied to the nozzle; and a controller to control operation of the flux regulator.

### TECHNICAL FIELD

The present invention relates to a sprinkler and a method for controlling the same. More particularly, the present invention relates to a sprinkler capable of uniformly supplying water on a variety of topographies without any waste of water, and a method for controlling the same.

### BACKGROUND ART

In general, sprinklers refer to devices installed on farms, lawn gardens, and other places to water plants thereon. The sprinklers can be classified into a pop-up type sprinkler, a stationary type sprinkler, and a rotary type sprinkler combining the pop-up type and the stationary type in terms of watering manner. For the pop-up type sprinkler, a sprinkler head concealed under the ground at ordinary times is raised above the ground to spray water in operation, and is then returned back to an original location after the operation. The stationary type sprinkler is exposed above the ground at ordinary times, and sprays water while rotating in operation. Although the stationary type sprinkler has a merit in view of inexpensive price, it generally causes inconvenience in grass cutting due to collision with a lawn mower. The rotary type sprinkler is configured to slowly spray water while rotating, and thus is well suited for large areas.

In recent times, the rotary type sprinkler is generally used in various fields. In practice, with a water supply pipe buried under the ground, a number of rotary type sprinklers are disposed at constant intervals to supply water over a wide area.

### DISCLOSURE

### Technical Problem

A conventional sprinkler is configured to supply water at a constant hydraulic pressure, which results in water supply to a limited area. Further, since the conventional sprinkler supplies water to a circular area around the sprinkler, it fails to uniformly supply water in a wide area or in a variety of topographies. In order to solve these problems, it is necessary to place the sprinklers such that circular areas to be supplied with water overlap each other. However, when the sprinklers are disposed in this manner, a great number of sprinklers are not only required, but water is also wasted due to overlapping of the water supplying areas. Furthermore, an increase in the number of sprinklers causes an increase in installation costs of the sprinklers, and requires more complicated placement of the water supply pipe, which also increases costs for maintenance and repair of the water supply pipe. In particular, to spray water distally on an area having a narrow distal end as in a corner area, water must be sprayed to a portion of the area which does not require water supply, thereby causing unnecessary waste of water. Therefore, there is a need of solving these problems of the conventional sprinkler.

The present invention has been made in view of the above problems of the conventional techniques, and an aspect of the present invention is to provide a sprinkler capable of uniformly supplying water in a variety of topologies. It is another aspect of the present invention to provide a sprinkler capable of preventing water waste. It is a further aspect of the present invention to provide a sprinkler allowing simple placement of a water supply pipe. It is yet another aspect of the present invention to provide a sprinkler capable of realizing various illumination effects.

### Technical Solution

In accordance with an aspect of the present invention, a sprinkler includes: a fluid supply pipe to supply fluid; a nozzle to spray the fluid supplied from the fluid supply pipe; a flux regulator to control an amount of the fluid supplied to the nozzle; and a controller to control operation of the flux regulator.

The flux regulator may include a manifold pipe communicating with the nozzle; and a first valve to selectively regulate the fluid supplied through the manifold pipe. Preferably, the flux regulator includes a second valve disposed between the water supply pipe and the manifold pipe to regulate the fluid supplied to the manifold pipe.

The flux regulator may include a second valve to regulate the fluid supplied to the nozzle.

The sprinkler may further include a direction regulator to change a direction of the nozzle. The direction regulator may include a driven shaft and a driving unit to rotate the driven shaft. The driven shaft may include a changing part to change a water spraying direction of the nozzle. The changing part may include a support to restrict movement of the nozzle. Preferably, the changing part includes a ball provided to the support, a coupling piece coupled to the ball, and a restriction member provided to the coupling piece to restrict movement of the ball.

For improved functionality, the sprinkler may further include a lighting device to illuminate light in a water spraying direction.

In accordance with another aspect of the present invention, a method for controlling a sprinkler includes receiving spraying information; determining a distance and area to be sprayed with a fluid according to the received spraying information; and spraying the fluid by controlling at least one of a pump, a fluid controller, a nozzle, and a direction regulator according to the determined fluid spraying distance and area.

In one embodiment, the step of spraying the fluid includes selectively regulating the fluid supplied through a manifold pipe communicating with the nozzle.

In one embodiment, the step of spraying the fluid includes selectively regulating the fluid supplied to the manifold.

In one embodiment, the step of spraying the fluid includes spraying the fluid while rotating the nozzle with the direction regulator or spraying the fluid by selecting a specific nozzle among nozzles disposed in a circular arrangement.

In one embodiment, the step of spraying the fluid includes spraying the fluid while changing a spraying angle of the nozzle.

Preferably, the method of the present invention may further include illuminating light to the spraying fluid. Here, the step of illuminating light includes changing brightness and color of light depending on input presentation data.

### Advantageous Effects

As set forth above, according to the present invention, the sprinkler can supply a fluid to a wide area in a variety of directions and topologies, which enables a reduction in the number of sprinklers. With such a reduction in the number of sprinklers, the sprinkler according to the present invention can decrease time and cost for maintenance, repair and installation thereof, and enables more efficient space utilization for other uses.

In addition, according to the present invention, the sprinkler can control the spraying distance and direction of fluid, which enables fluid supply only to a desired location, and reduction in fluid consumption leading to cost reduction.

Further, according to the present invention, since a fluid can be supplied to a complicated wide area even with a decreased number of sprinklers, it is possible to simplify placement of a water supply pipe, and to reduce time and cost for maintenance and repair of the water supply pipe.

Further, according to the present invention, the sprinkler is provided with a lighting device, which can illuminate light toward the nozzle spraying a fluid, and can change brightness and color of light in conjunction with an amount of the spraying fluid, providing various illumination effects and psychological stability.

### DESCRIPTION OF DRAWINGS

FIG. 1 is a perspective view of a sprinkler according to a first embodiment of the present invention;

FIG. 2 is a cross-sectional view of the sprinkler according to the first embodiment of the present invention;

FIG. 3 is a plan view of nozzles of the sprinkler according to the first embodiment of the present invention;

FIG. 4 is an exploded perspective view of a changing part of the sprinkler according to the first embodiment of the present invention;

FIG. 5 is a block diagram of the sprinkler according to the first embodiment of the present invention;

FIG. 6 is a schematically enlarged view of a flux regulator of a sprinkler according to a second embodiment of the present invention;

FIG. 7 is a block diagram of the sprinkler according to the second embodiment of the present invention; and

FIG. 8 is a flow chart of a method for controlling a sprinkler according to one embodiment of the present invention.

### BEST MODE

Exemplary embodiments of the present invention will be described in detail with reference to the accompanying drawings. Herein, the drawings may be exaggerated in thickness of lines or scale of components for the purpose of descriptive convenience and clarity only. Furthermore, terms used herein should be defined in consideration of functions of components of the present invention and thus can be changed according to the custom or intention of users or operators. Therefore, definition of such terms should be determined according to overall disclosures set forth herein. Herein, although the embodiments of the present invention will be described as spraying water, the present invention is riot limited to water, and can be applied to supplying various kinds of fluids, such as liquid fertilizers, chemical agents, etc.

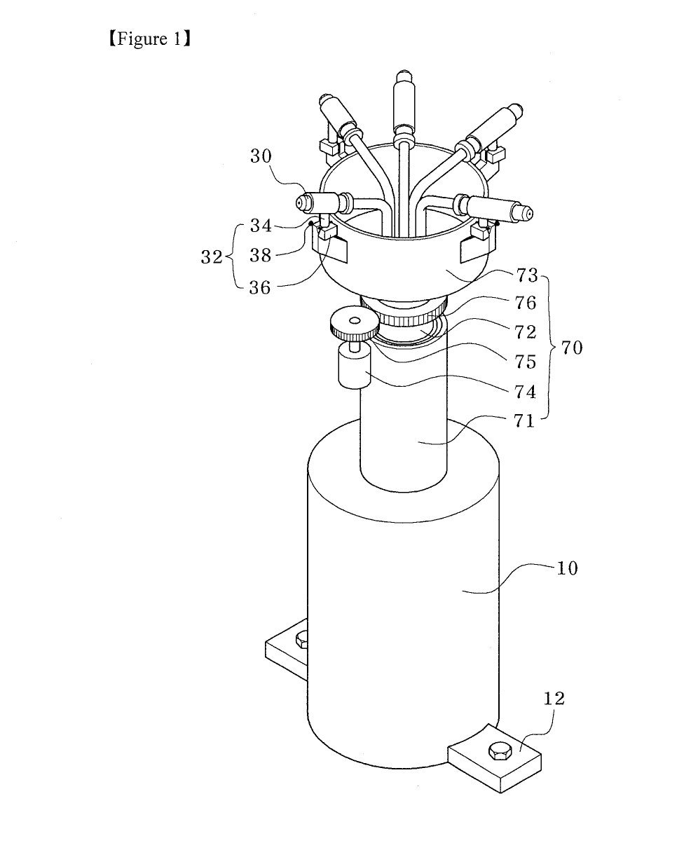

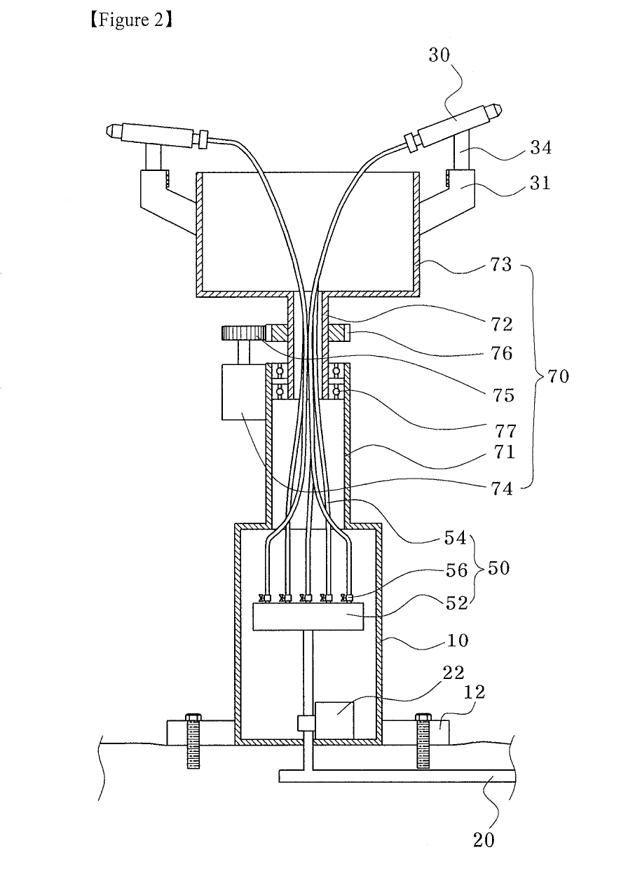

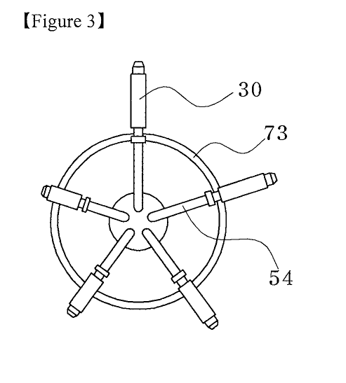

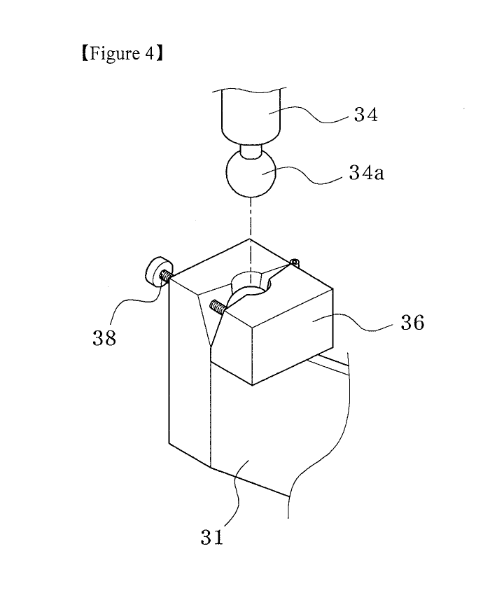

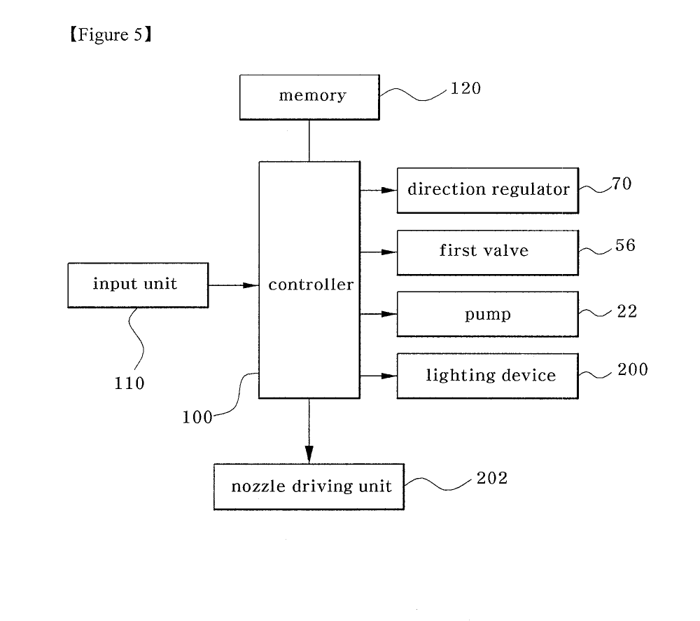

FIG. 1 is a perspective view of a sprinkler according to a first embodiment of the present invention, FIG. 2 is a cross-sectional view of the sprinkler according to the first embodiment of the present invention, FIG. 3 is a plan view of a nozzle of the sprinkler according to the first embodiment of the present invention, FIG. 4 is an exploded perspective view of a changing part of the sprinkler according to the first embodiment of the present invention, and FIG. 5 is a block diagram of the sprinkler according to the first embodiment of the present invention.

Referring to FIGS. 1 to 5, the sprinkler according to the first embodiment includes a body 10, a water supply pipe 20 to supply water to the body 10, nozzles 30 to spray water supplied from the water supply pipe 20, a flux regulator 50 to adjust an amount of water supplied to the nozzles 30, and a controller 100 to control operation of the flux regulator 50.

Water is supplied according to spray information, such as data input to the controller 100 through an input unit 110 or data stored in a memory 120. The supply of water can be remotely controlled by the input unit 110.

A pump 22 is provided to the water supply pipe 20 or a water reservoir (not shown). When the pump 22 is activated, water flows from the water supply pipe 20 into the nozzles 30 via the flux regulator 50, and is sprayed from the nozzles 30. In this embodiment, the pump 22 is provided to the water supply pipe 20, but the present invention is not limited to this construction. Rather, there can be various modifications in placement of the pump such as placement in a connection duct positioned between the water supply pipe and the flux regulator. Further, in this embodiment, the plural nozzles are disposed at substantially the same height in a circular arrangement. However, the nozzles can be disposed at different heights or at different angles. Of course, the sprinkler may include a single nozzle to supply water. As such, since the plural nozzles 30 are disposed at the same angle or at different angles in the sprinkler, a spraying angle and distance of water can be determined depending on the shape and placement construction of the nozzles, after the nozzles 30 intended to supply water are determined.

The flux regulator 50 includes manifold pipes 54 communicating with the nozzles 30, and first valves 56 to selectively regulate water supplied through the manifold pipes 54. In this embodiment, the manifold pipes 54 are connected with a chamber 52 such that water supplied from the water supply pipe 20 passes through the chamber 52 and manifold pipes 54 into the nozzles 30. The first valves 56 may be solenoid valves, and controlled by the controller 100 to selectively regulate water supplied to the nozzles. When a constant amount of water is supplied into the chamber 52, falling locations of water sprayed from the nozzles 30 can be changed depending on whether the first valves 56 are open or closed. For example, in the case where the sprinkler includes a plurality of manifold pipes 54, some of the first valves 56 are closed to allow water to be sprayed a far distance through some of the nozzles 30, compared to the case where all of the first valves 56 are open. In other words, it is possible to control the falling locations of water depending on the number of open or closed first valves 56. Specifically, when increasing the number of manifold pipes 54 closed by the associated first valves 56, a flowing speed of water through the other manifold pipes 54 not closed increases, thereby increasing a spraying distance of water. Of course, the falling location of water can be determined by an output of the pump 22, installation angles and shapes of the nozzles 30, and so on.

The controller 100 controls operations of the pump 22, the nozzles 30, the flux regulator 50, a direction regulator 70, etc. to control places, distances, directions, and fluxes of water according to input spray information. For example, the controller 100 allows water to be supplied by increasing the output of the pump 22, if there is an area where water is not supplied by the sprinkler under the current conditions including an opening degree of the flux regulator 50, the shapes and placement angles of the nozzles 30, etc.

In this embodiment, the sprinkler includes the direction regulator 70 to change the directions of the nozzles 30. The direction regulator 70 includes a driven shaft 72, and a driving unit 74, 75 and 76 to rotate the driven shaft 72. The direction regulator 70 is controlled by the controller 100, and serves to rotate the nozzles 30 such that water sprayed from the nozzles 30 can be supplied to a wide area or a desired location. For example, in the case where there is an area where water is not sprayed, the controller 100 rotates the driven shaft 72 so as to allow water to be supplied to that area. Alternatively, the controller 100 can control the operation of the direction regulator 70 while rotating the driven shaft 72 so as to allow water to be supplied to a desired location and area.

Preferably, the nozzles 30 are disposed on the driven shaft 72 or disposed to be moved in connection with movement of the driven shaft 72. In this embodiment, the nozzles 30 are supported by a support 34. However, it should be noted that the present invention is not limited to this configuration, and that there can be various modifications, such as insertion of the nozzles into a coupling hole of the driven shaft 72, coupling of the nozzles to the driven shaft 72 with a separate fastener, etc.

The driven shaft 72 is rotatably coupled to the body 10 or to a hollow shaft 71 that is coupled to the body 10 as shown in FIG. 1. When the driven shaft 72 is provided to the hollow shaft 71, a bearing 77 or other members are preferably disposed between the hollow shaft 71 and the driven shaft 72. When the driven shaft 72 is rotated by the driving unit 74, 75 and 76, the nozzles 30 connected to the driven shaft 72 are also rotated. Since the manifold pipes 54 extend from the body 10 into the nozzles 30 through the hollow shaft 71 and driven shaft 72, the driven shaft 72 is preferably configured so as not to rotate 360 degrees to prevent twisting of the manifold pipes 54.

The driving unit 74, 75 and 76 includes a motor 74 disposed on the hollow shaft 71, a driving gear 75 provided to a rotational shaft of the motor 74, and a driven gear 76 provided to the driven shaft 72 and engaging with the driving gear 75. When the motor 74 is driven, the driven shaft 72 is rotated to regulate the directions of the nozzles 30.

Preferably, the driven shaft 72 further includes a changing part 32 to regulate a spraying direction or a placement angle of each nozzle 30. The changing part 32 includes a support 34 to restrict movement of the nozzle 30, a coupling piece 36 engaging with a ball 34a, and a restriction member 38 provided to the coupling piece 36 to restrict movement of the ball 34a. The support 34 may mechanically restrict a location of the nozzle 30 or electronically restrict the location of the nozzle 30 via a motor such as an actuator. In this embodiment, the support 34 will be described as mechanically restricting the location of the nozzle 30 as one example. The support 34 is preferably provided with a circular or elliptical ball 34a to achieve change in location of the nozzle 30. The coupling piece 36 may be integrally formed with a securing part 31 disposed on a resting part 73, or may include two sub-pieces hingably provided at one point on the resting part 73, as shown in FIG. 4. Here, the resting part 73 is formed on the driven shaft 72. The restriction member 38 has threads formed thereon and can adjust a fastening force of the coupling piece 36 by rotation. When a separation between the two sub-pieces of the coupling piece 36 is increased by adjusting the restriction member 38, the ball 34a is moved, allowing regulation of the angle of the nozzle 30. The method of adjusting the fastening force in this manner is well known to a person skilled in the art, and a detailed description thereof will be omitted herein.

Preferably, the sprinkler further includes a lighting device 200 to illuminate light in a water spraying direction. The lighting device 200 is controlled by the controller 100, and is detachably attached to any of the body 10 and the driven shaft 72 of the sprinkler. The lighting device 200 will be described in detail as below.

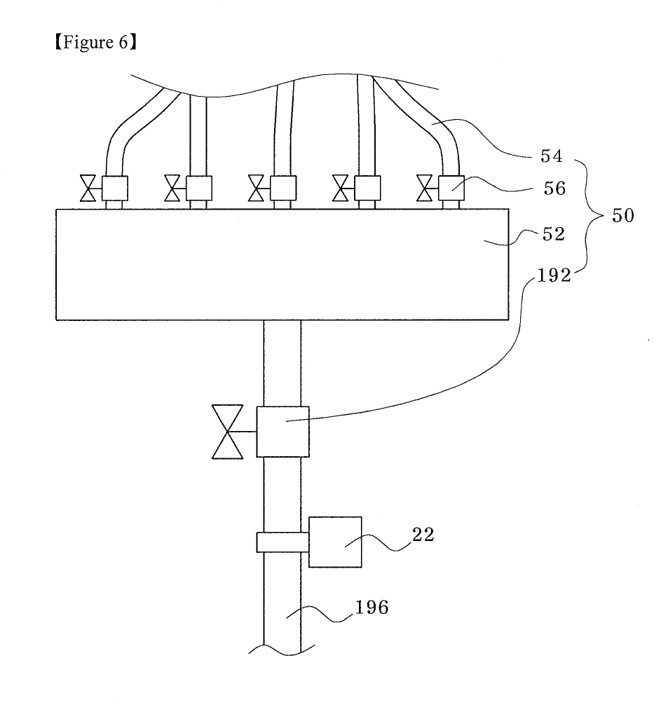

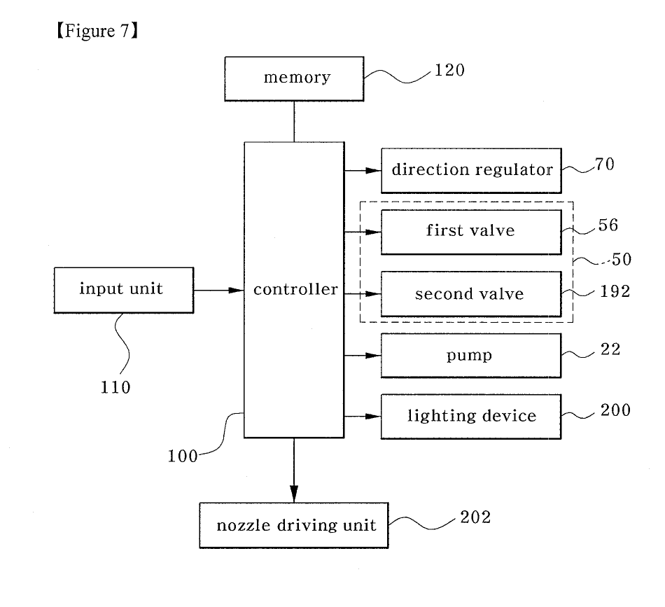

FIG. 6 is a schematically enlarged view of a flux regulator of a sprinkler according to a second embodiment of the present invention, and FIG. 7 is a block diagram of the sprinkler according to the second embodiment of the present invention. Herein, the same components as those of the first embodiment in view of structure and operation will be denoted by the same reference numerals, and detailed descriptions thereof will be omitted.

Referring to FIGS. 6 and 7, a flux regulator 50 of this embodiment further includes a second valve 192 to regulate water supplied to the nozzles 30 (see FIG. 2). The second valve 192 includes a solenoid valve and the like, and serves to selectively regulate water flow according to a control signal from the controller 100 (see FIG. 5). The second valve 192 is disposed between the water supply pipe 196 and the manifold pipes 54 to regulate water supplied to the manifold 54. By selectively opening or closing the second valve 192, the supply of water is regulated. In this manner, when the supply of water is regulated, a water spraying distance can be changed, thereby allowing water to be continuously supplied over a wide area. In this embodiment, the second valve 192 is provided to the water supply pipe 196. However, the present invention is not limited this configuration, and there are various modification in placement of the second valve, such as placement of the second valve 192 on a manifold pipe 154, and so on.

Next, operation and controlling method of the sprinklers according to the first and second embodiments of the present invention will be described.

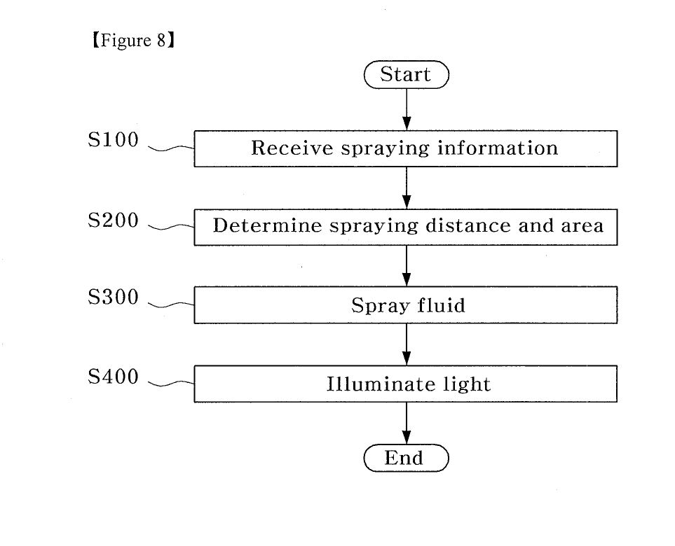

FIG. 8 is a flow chart of a method for controlling a sprinkler according to one embodiment of the present invention.

Referring to FIGS. 2, 5, 7, and 8, after mounting a body 10 of the sprinkler on the ground with a connector 12, a water supply pipe 20 is connected to the body 10 to constitute the sprinkler. With the sprinkler set in this manner, water is supplied around the sprinkler. At this time, a manner of supplying water is determined according to spraying information input from an input unit 110 such as a remote controller, a terminal unit, a computer, etc. When the spraying information is input (S100), a controller 100 determines a distance and area to be supplied with water (S200). On the other hand, a memory 120 stores various kinds of data corresponding to the input spraying information, control data related to a direction regulator 70, a flux regulator 50, brightness and color of a light device 200, etc. When the spraying information stored in the memory 120 is input from the input unit 110, the controller 100 controls operation of the sprinkler corresponding to the control data stored in the memory 120. Further, when receiving an input of specific spraying information newly generated by a user to supply water to a specific area, the controller operates the sprinkler according to this newly generated specific information. At this time, the sprinkler can supply water to the specific area, or can supply water while rotating, according to the input spraying information.

When the water spraying distance and area is determined, the controller 100 controls at least one of a pump 22, the flux regulator 50, nozzles 30, and the direction regulator 70 to spray water (S300). Hereinafter, the method of controlling the respective components by the controller 100 will be described in detail.

First, a method of controlling the flux regulator 50 by the controller 100 to spray water will be described. The controller 100 selectively regulates water supplied through manifold pipes 54 communicating with the nozzles 30. If some of first valves 56 are closed, a flowing speed of water increases, so water can be supplied to a far distance. At this time, the closed first valves 56 are selectively determined according to input spraying information. In other words, it is possible to supply water to a far distance by opening some of nozzles 30 corresponding to a target area located at the far distance while closing the other nozzles 30 corresponding to an undesired area, among a plurality of nozzles located at different heights in a circular arrangement. At this time, opening and closing the nozzles 30 can be performed by the first valves 56. In other words, when some of the manifold pipes 54 communicating with the associated nozzles 30 are closed by the associated first valves 56, water is not supplied to those associated nozzles 30. Further, to achieve uniform supply of water over a wide area, a second valve 192 is regulated along with the control of other components as described above. When the second valve 192 is selectively opened or closed, a falling location of water sprayed from the nozzles 30 can be varied. In this manner, the water supplying location and distance can be adjusted by controlling the first and second valves 56 and 192.

With the sprinkler of the invention, water can be supplied to a desired location not only by selectively opening the manifold pipes 54 as described above, but also by controlling operation of the direction regulator 70. In other words, when the controller 100 drives a motor 74 to supply water to a desired location, a driven shaft 72 and the nozzles 30 are rotated.

In addition, the water supplying distance can be adjusted by controlling the pump 22. In other words, water can be supplied to a far distance by increasing an output of the pump 22, or can be supplied to a near distance by lowering the output of the pump 22.

Further, the water supplying distance and location can be adjusted by changing the spraying angles of the nozzles 30. In this embodiment, there is only a description of the component capable of mechanically changing the spraying angles of the nozzles 30, but it would be apparent to those skilled in the art that there are a number of components capable of changing the spraying angles of the nozzles 30 in response to a control signal generated in the controller 100. For example, the locations or spraying angles of the nozzles 30 can be changed by driving a nozzle driving unit 200 such as an actuator by a control signal. The components such as the actuator are obvious to those skilled in the art, and a detailed description and drawings thereof will be omitted herein.

Preferably, the sprinkler illuminates light to spraying water (S400). The controller 100 controls operation of a light device 200 to illuminate light to the spraying water. For example, the controller 100 enables intermittent or continuous variation of brightness or color of the lighting device 200 in response to spraying information from the input unit 110. The controller 100 controls the lighting device 200 to illuminate light while rotating. Alternatively, with a plurality of lighting devices 200 provided to the sprinkler, the lighting devices 200 are selectively turned on or off to illuminate light to the spraying water by the controller 100. At this time, the spraying information includes presentation data for realizing various illumination effects, and the like. On the other hand, the change in brightness or color of the lighting device 200 can be performed by a brightness changing mechanism or a color changing mechanism not shown in the drawings.

Although the present invention has been described with reference to the embodiments and the accompanying drawings, the embodiments are given by way of illustration only, and, it will be apparent to those skilled in the art that various modifications and other equivalent embodiments can be made without departing from the scope of the present invention.

Further, the sprinklers described with reference to the accompanying drawings are given by way of illustration only, and the sprinkler according to the present invention can be applied to other devices for supplying fluids such as oil. Therefore, the scope of the present invention should be limited only by the accompanying claims.

1. A sprinkler, comprising:
a fluid supply pipe to supply fluid;
a nozzle to spray the fluid supplied from the fluid supply pipe;
a flux regulator to control an amount of the fluid supplied to the nozzle; and
a controller to control operation of the flux regulator.

2. The sprinkler according to claim 1, wherein the flux regulator comprises a manifold pipe communicating with the nozzle, and a first valve to selectively regulate the fluid supplied through the manifold pipe.

3. The sprinkler according to claim 2, wherein the flux regulator further comprises a second valve disposed between the water supply pipe and the manifold pipe to regulate the fluid supplied to the manifold pipe.

4. The sprinkler according to claim 1, wherein the flux regulator comprises a second valve to regulate the fluid supplied to the nozzle.

5. The sprinkler according to claim 1, further comprising: a direction regulator to change a direction of the nozzle.

6. The sprinkler according to claim 5, wherein the direction regulator comprises a driven shaft and a driving unit to rotate the driven shaft.

7. The sprinkler according to claim 6, wherein the driven shaft comprises a changing part to change a water spraying direction of the nozzle.

8. The sprinkler according to claim 7, wherein the changing part comprises a support to restrict movement of the nozzle.

9. The sprinkler according to claim 8, wherein the changing part comprises a ball provided to the support, a coupling piece coupled to the ball, and a restriction member provided to the coupling piece to restrict movement of the ball.

10. The sprinkler according to claim 1, further comprising: a lighting device to illuminate light in a water spraying direction.

11. A method for controlling a sprinkler, comprising:
receiving spraying information;
determining a distance and area to be sprayed with a fluid according to the received spraying information; and
spraying the fluid by controlling at least one of a pump, a fluid controller, a nozzle, and a direction regulator according to the determined fluid spraying distance and area.

12. The method according to claim 11, wherein the step of spraying the fluid comprises selectively regulating the fluid supplied through a manifold pipe communicating with the nozzle.

13. The method according to claim 11, wherein the step of spraying the fluid comprises selectively regulating the fluid supplied to the manifold.

14. The method according to claim 11, wherein the step of spraying the fluid comprises spraying the fluid while rotating the nozzle with the direction regulator or spraying the fluid by selecting a specific nozzle among nozzles disposed in a circular arrangement.

15. The method according to claim 11, wherein the step of spraying the fluid comprises spraying the fluid while changing a spraying angle of the nozzle.

16. The method according to claim 11, further comprising: illuminating light to the spraying fluid.

17. The method according to claim 16, wherein the step of illuminating light comprises changing brightness and color of light depending on input presentation data.
